(19) United States
(12) Patent Application Publication
(10) Pub. No.: US 2014/0226281 A1
(43) Pub. Date: Aug. 14, 2014

(54) MOUNT FOR A TABLET PC

(71) Applicant: Arman Emami, Berlin (DE)

(72) Inventor: Arman Emami, Berlin (DE)

(21) Appl. No.: 14/131,742

(22) PCT Filed: Jul. 6, 2012
(86) PCT No.: PCT/DE2012/000699

§ 371 Date: Mar. 24, 2014

(30) Foreign Application Priority Data
Jul. 9, 2011 (DE) 10 2011 107 039.0

(51) Int. Cl. G06F 1/16

(52) U.S. Cl. CPC G06F 1/1683
USPC 361/679.56; 248/122.1; 248/124.2

(57) ABSTRACT

A mount (1) for a tablet PC (2), with a base (3) having a weight, at least one first telescopic aim (5) which is rotatably fastened to the base (3) by way of at least a lower articulation (4), and a retaining element (9) for the tablet PC (2), which is rotatably fastened to the telescopic arm by way of at least an upper articulation (8) and includes at least one retaining arm (10) for the tablet PC (2).

The invention relates to a mount for a tablet PC, tablet or touchpad and, in particular, a universally usable mount for a tablet PC.

Tablet PCs are very flat personal computers (PCs) with a screen approximately the size of a DIN A4 page, which are similar to a writing tablet. Tablet PCs can usually be operated without a keyboard or mouse, where they are operated using the fingers or a stylus via a touchscreen or a multi-touch screen.

A tablet PC is very versatile due to its mobility, numerous programs and applications, also known as apps, and various mobile communications interfaces such as WLAN or mobile communication standards such as, for example, UMTS.

A user of a tablet PC has to either hold it with one hand, put it down on a table, for example, or use a mount for the tablet PC. Mounts exist for different areas of application such as, for example, for a desk, a car or an airplane.

However, these specialized mounts restrict the user's mobility, since he either has to switch between different mounts or limit his mobility to the mounts.

It is the object of the invention to increase the flexibility of using a tablet PC.

This object is achieved according to the invention with the features of claim 1. Advantageous further developments of the invention are defined in the dependent claims.

The invention relates to a mount for a tablet PC, comprising a base having a weight, at least one first telescopic arm which is rotatably fastened to the base by way of at least a lower articulation, and a retaining element for the tablet PC, which is rotatably fastened to the telescopic arm by way of at least an upper articulation and comprises at least one retaining arm for the tablet PC.

This versatile mount considerably extends the flexibility of using a tablet PC. The tablet PC can now be used in the mount while standing, sitting and lying in many places and in numerous positions. The mount can be used in all the rooms of a house, outside, in the gym, in public areas or facilities and on means of transport such as, for example, on an airplane or cruise ship. When used on a moving base, the mount can either be fixed in place by means of the weight in the base and/or by means of a fastening to the base. The mobility can be increased, for example, by means of an optimally retractable handle or rollers of the mount.

The base with its weight, which is preferably arranged in the base, is dimensioned such that the mount is secure, even when the telescopic arm is extended to its maximum and/or on swiveling. The telescopic arm is rotatably mounted. This includes a movement or adjustment about a perpendicular axis, about a horizontal axis and/or about an inclined axis. The terms perpendicular and horizontal refer to a mounting surface of the base part or to the base, on which the mounting surface rests. The two adjustment possibilities can be achieved by way of several articulations or by way of a single articulation such as, for example, a ball joint. The telescopic arm can comprise one or more extendable telescopic sections. The retaining element for receiving or fastening the tablet PC to the mount is fastened to the telescopic arm by way of an upper articulation which can have the same characteristics as the lower articulation. Ideally, at least one of the two articulations is designed to be rotatable and swivelable. The retaining element supporting the tablet PC has at least one retaining arm for holding and for fastening the tablet PC respectively. The tablet PC can be exclusively mounted on or fastened to a retaining arm, between several retaining arms or between the retaining element and one or more retaining arms.

The mount can comprise a second telescopic arm which is swivelably fastened to the first telescopic arm by way of a central articulation, where the upper articulation is arranged on the second telescopic arm. The mount can be even better adapted to the user's needs with a second or even additional telescopic arms.

The first and/or the second telescopic arm can comprise light metal such as, for example, aluminum or can be composed entirely of the light metal. This minimizes the weight of the movable portion of the mount, thus increasing the stability and the ease of use. A different lightweight, but sturdy material such as, for example, carbon can also be used.

The retaining arm can comprise a detachable fastening for the tablet PC such as, for example, a spring mechanism, a latching connection, a clamping device, a screwed connection and/or a clamped connection by means of a flexible material. Common fastenings, which establish a connection which is strong enough to be able to use the tablet PC safely, and which make it possible to insert the tablet PC as well as remove it in a particularly simple manner, are suitable.

The retaining element can comprise four retaining arms arranged in the shape of a cross. The number of retaining arms can be selected with due regard to the mount, the tablet PC, the operation and/or the design. Where there are several retaining arms, these define a receiving or holding area in which the tablet PC is held, for example by means of clamping or engaging between the individual, possibly flexible retaining arms.

The retaining arm can be adjustable in a longitudinal direction, thus allowing it to be adjusted to different tablet PCs.

At least one of the articulations can comprise a locking mechanism such as, for example, a push button, an adjusting screw, a rotary switch or the like. The locking mechanism allows a specific adjustment of the articulation during operation and blocks the articulation against unintentional adjustment. The locking mechanism can be switched on and off, so that the articulation moves freely, does not move at all or, alternatively, only moves upon actuation of a push button for example. This increases the stability of the mount and the ease of use.

At least the upper articulation can be a ball joint. Multiple degrees of freedom can be achieved with a ball joint in a simple and elegant manner.

The retaining element or a portion of the retaining element and/or the base can be detachably fastened. Therefore, the retaining element or a portion thereof such as, for example, a retaining arm can be fastened and removed by the upper articulation or a retaining element support fastened to the articulation. This makes it possible to adjust the mount to different tablet PCs and to provide the mount with different properties respectively such as interfaces for the tablet PC or control units for the user. The detachable fastening is designed such that a secure, but preferably easily detachable connection is produced. The base and the lower articulation respectively or the first telescopic arm can also be detachably fastened. Thus, different versions of the base containing, for example, various electric auxiliary modules or equipment for the tablet PC can be used. A modular system, which can be assembled according to the user's wishes and which can grow with his needs, can be created with an exchangeable base and/or retaining element. Likewise, the telescopic arm or telescopic arms can be incorporated into the extendable modular system.

A power supply having an automatic cable retraction system for a power cable can be arranged in the base. The power supply can be used for consumers in the base and/or for the tablet PC. The automatic cable retraction system allows for a space-saving and visually attractive accommodation. Any control elements required such as a push button can be disposed externally on the base. The power supply and the cable retraction system respectively can also be controlled electrically or electronically, for example by means of a (mobile) control unit of the mount and/or an application of the tablet PC.

A communication unit, a data storage unit and/or a battery charging unit for the tablet PC can be arranged in the base. The communication unit can consist of one or more units and include the following functionalities: interfaces for the tablet PC and/or the mount such as, for example, WLAN/LAN, Bluetooth, USB, Firewire, eSATA, ISDN, etc. or indicators such as displays, lights, or control elements such as switches and buttons or output devices such as loudspeakers or projectors. This includes all uni-directional and bi-directional interfaces between the user, tablet PC, mount and the environment. The data storage unit can consist of one or more units and include, inter alia, volatile memories such as RAM and non-volatile memories such as hard disks, as well as a combination of both types.

At least one line can extend from the base through the telescopic arms to the retaining element. This can be a power supply line, a communications line or a data or signal line. The line can be provided for the tablet PC and/or elements of the mount such as, for example, a control unit or loudspeakers.

The line can be connected to a tablet PC contact area which can be arranged on the retaining element, preferably on the retaining arm. The contact area can be designed such that the tablet PC, when inserted into the mount, makes contact with the contact area directly. It is also possible that the contact is first made by the user, for example by throwing a switch. The contact area can be used to transmit data and signals and/or to charge a battery of the tablet PC.

At least one of the articulations can comprise an actuator. The articulation can be adjusted by way of the actuator, without requiring muscle power, thus increasing the ease of use. The mount can include a controller which activates the required motor or motors based on the user's desired position.

The mount can comprise a preferably mobile control unit for controlling the actuator. The control unit can be a (removable) remote control, or a control unit which is fixed to the mount, for example to the retaining element. The control unit can also be configured as an application on the tablet PC.

The invention will be described in more detail below using the drawings, where:

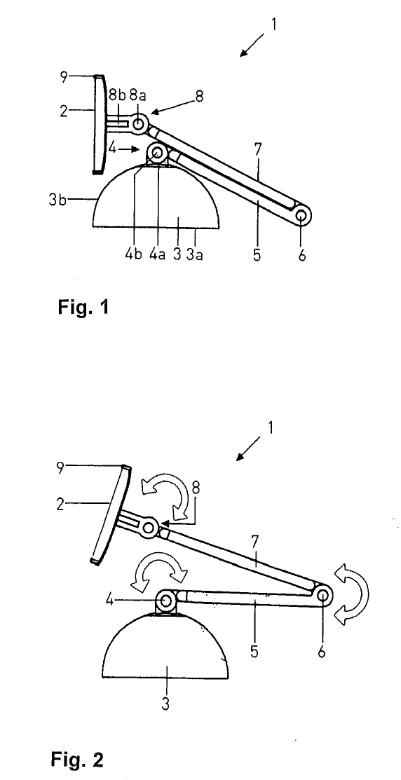

FIG. 1 shows a side view of a mount for a tablet PC according to the invention.

FIG. 2 shows a side view of a partially extended mount according to the invention.

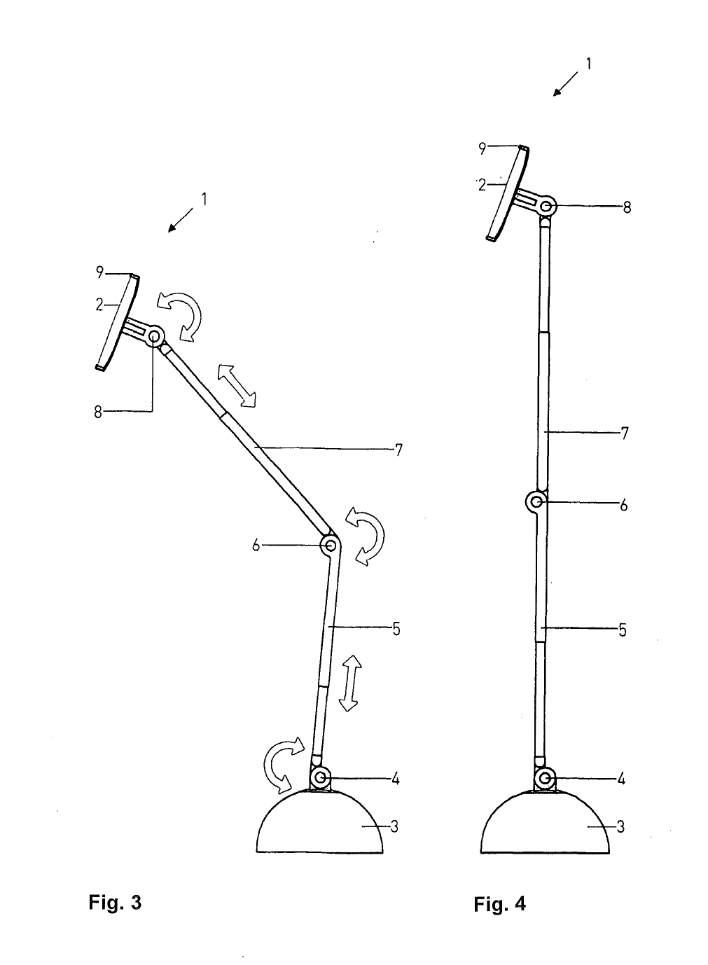

FIG. 3 shows a side view of a partially extended mount according to the invention.

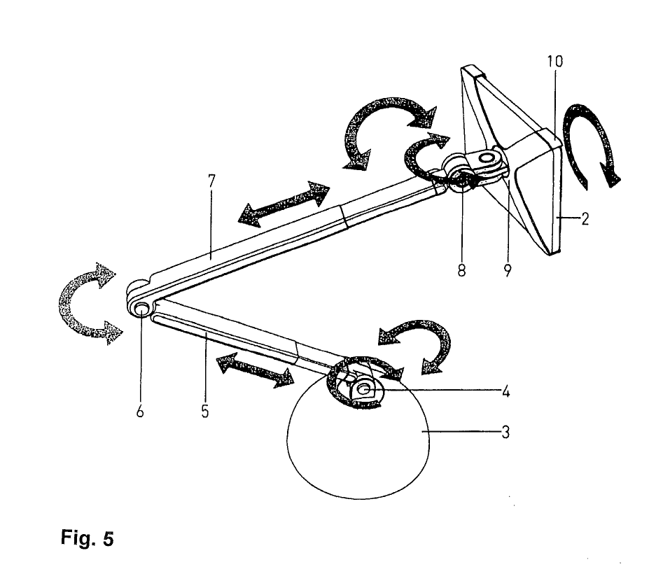

FIG. 4 shows a side view of a partially extended mount according to the invention.

FIG. 5 shows a three-dimensional representation of the mount according to the invention.

The drawings are only intended to explain the invention and do not limit it. The drawings and the individual parts are not necessarily to scale. The same reference numerals designate the same or similar parts.

The general construction of a mount 1 for a tablet PC 2 will be described first by means of FIGS. 1 to 4. The tablet PC 2 is a mobile communications device having an area approximately the size of a DIN A4 page.

The mount 1 comprises a base 3 for mounting on a surface such as, for example, a floor, table or other piece of furniture. The base 3 has a footprint 3a, with which it stands on the surface. In the drawing, as is probably also the case for most applications, the footprint is aligned at least substantially levelly or horizontally. A housing 3b of the base 3 connects to a top of the footprint 3a. The housing 3b has an approximately hemispherical form, in order to provide freedom of movement for further components such as the arm of the mount.

A weight is integrated into the housing 3b. This weight can be a singular additional weight, for example, made of lead. The weight can also be a component of the footprint 3a or the housing 3b. The weight is dimensioned such that it guarantees the stability of the mount 1 during operation.

Furthermore, a power supply, various interfaces for the user, the tablet PC 2 and/or the mount 1 itself, data storage and/or a battery charging unit for the tablet PC can be provided in the base 3.

A lower articulation 4, which movably connects a first telescopic arm 5 with the base 3, is arranged on top of the base 3. The lower articulation 4 can, as shown here, consist of two separate individual articulations 4a and 4b, or of one articulation such as, for example, a ball joint. The articulation 4a allows the first telescopic arm 5 to move about a perpendicular or vertical axis, which can also be described as rotation. The second articulation 4b allows a movement about a horizontal axis, which can also be referred to as swiveling. The ball joint allows both movements simultaneously. Both articulations 4a and 4b, and the one articulation respectively have a locking mechanism, which is not shown for the sake of clarity, which allows a selective movement of the articulation.

The first telescopic arm 5 has an extendable telescopic mechanism, so that the length of the first telescopic arm can be varied. The telescopic mechanism can also be designed to be lockable. A central articulation 6 which movably connects a second telescopic arm 7 with the first telescopic arm 5 is fastened to the other end of the first telescopic arm 5. This articulation 6 can be configured, to a certain extent, as a hinge which allows a swiveling movement.

The second telescopic arm 7 is constructed in the same way as the first telescopic arm 5, whereby it has a greater length than the first telescopic arm 5, so that complete folding or collapsing of the mount 1 is possible (FIG. 1), without the lower articulation 4 and an upper articulation 8 impeding each other or colliding with one another. The telescopic arms 5, 7 consist at least partially of a lightweight material such as aluminum and/or carbon, in order to minimize the weight.

The upper articulation 8 connects a retaining element 9 for the tablet PC 2 with the second telescopic arm 7 and, in addition, with the base 3. The upper articulation 8 can, as shown here, consist of two separate individual articulations 8a and 8b, or one articulation such as, for example, a ball joint. The articulation 8a allows a movement of the retaining element 9 about a horizontal axis, which can also be referred to as swiveling. The second articulation 8b allows a movement about a vertical or inclined axis, which can also be referred to as swiveling. Both swiveling movements can also be viewed as a combined rotary movement. Both articulations 8a and 8b and the one articulation respectively have a locking mechanism, which is not shown for the sake of clarity, which allows a selective movement of the articulation.

The terms lower, central and upper articulation 4, 6 and 8 are actually arranged thus in FIGS. 2 to 4. In FIG. 1, the central articulation 6 is located below the lower articulation 4, which does not contradict the selected terms.

The articulation 8 or retaining element 9 has a further axis of rotation which is oriented perpendicularly to the retaining element 9 and the surface of the tablet PC 2 respectively and allows a rotation of the tablet PC. This function can also be performed by a ball joint.

The retaining element 9 has four retaining arms 10 arranged in the shape of a cross, which define or span a receiving area for the tablet PC. Of course, a different number of retaining arms 10 can also be selected. At least one retaining arm 10 is provided. In this case the retaining element 9 can only consist of the retaining arm 10.

The retaining arms 10 have a detachable fastening for the tablet PC 2 such as, for example, a spring mechanism, a latching connection, a clamping device, a screwed connection and/or a clamped connection by means of a flexible material. The clamped connection is formed here such that the retaining arms 10 are made of a flexible material such as plastic, whereby the elasticity or flexibility of the material and the distance and the length respectively of the retaining arms 10 are selected such that, on inserting the tablet PC 2 into the retaining element 9, the tablet PC 2 or its housing is clamped or engages between the retaining arms 10, is held there securely during use, and is easy to remove following use. The retaining arm 10 can comprise, at its outer end, a contact area which is angled for example, which engages around the tablet PC 2 and thus holds it. In order to adjust to different tablet PCs, at least one retaining arm 10 can be adjustable in a longitudinal direction.

The retaining element 9 or a portion of the retaining element 9 such as one or more retaining arms 10, and/or the base 3 can be detachably fastened. Thus, the mount 1 can be adjusted to various tablet PCs 2 by means of a simple replacement of the retaining element 9. By replacing the base 3, the mount 1 can be extended with various functionalities housed in the base 3.

At least one line can extend from the base 3 through the telescopic arms 5, 7 to the retaining element 9. The line can transmit data and/or power from the base 3 to the tablet PC 2 and vice versa. The line can be connected to a tablet PC contact area which is arranged on the retaining element 9, preferably on the retaining arm 10. Contact can be established directly between the electrics and/or electronics in the base 3 and the tablet PC 2 via the tablet PC contact area on inserting the tablet PC 2. The term line includes wired lines such as cables as well as wireless lines such as, for example, radio communications.

To increase the ease of operation, at least one of the articulations 4, 6, 8 can comprise an actuator which adjusts the articulation electrically. The actuator or actuators can be controlled with a preferably mobile control unit (remote control).

FIG. 5 shows a three-dimensional representation of the mount 1. The possible articulation movements and degrees of freedom respectively, which allow a very flexible positioning and inclination of the tablet PC 2, can be clearly seen. Thanks to the clever interaction of six axes of rotation and two extendable telescopic combinations, the retaining element 9 and, therefore, the tablet PC 2 can be placed in almost any position and adjustment. The tablet PC 2 can be positioned in a spatial radius of between approximately 24 cm and 150 cm with the mount 1.

A universal use of the mount 1, for example while standing or lying in bed, is therefore possible. The mount 1 provides a universal solution which is suitable for everyday use, so that the tablet PC 2 can be used in all positions such as on a table, while lying in bed or while standing, for example when cooking. The combination of a relatively heavy base part 3 and a lightweight aluminum arm guarantees a stable mount. The fixing buttons of the locking devices on the articulations 4, 8, 9, guarantee stability.

The mount 1 has been described as consisting of a base 3 and an arm or side arm consisting of one or more telescopic arms 5, 7, a retaining element 9 for the tablet PC 2 and connecting articulations 4, 6 and 8. The mount can also comprise a plurality of arms or side arms arranged on a base 3 for holding several tablet PCs 2.

1. A mount for a tablet PC (2), comprising
a base (3) having a weight,
at least one first telescopic arm (5) which is rotatably fastened to the base (3) by way of at least a lower articulation (4), and
a retaining element (9) for the tablet PC (2), which is rotatably fastened to the telescopic arm by way of at least an upper articulation (8), the retaining element comprising at least one retaining arm (10) for the tablet PC (2).

2. The mount according to claim 1, further comprising a second telescopic arm (7) which is rotatably fastened to the first telescopic arm (5) by way of a central articulation (6), wherein the upper articulation (8) is arranged on the second telescopic arm (7).

3. The mount according to claim 2, wherein the first (5) and/or the second telescopic arm (7) comprise(s) light metal and/or carbon.

4. The mount according to claim 1, wherein the retaining arm (10) comprises a detachable fastening for the tablet PC (2) selected from the group consisting of a spring mechanism, a latching connection, a clamping device, a screwed connection and a clamped connection by means of a flexible material.

5. The mount according to claim 1, wherein the retaining element (9) comprises four retaining arms (10) arranged in the shape of a cross.

6. The mount according to claim 1, wherein the retaining arm (10) is adjustable in a longitudinal direction.

7. The mount according to claim 2, wherein at least one of the articulations (4, 6, 8) comprises a locking mechanism.

8. The mount according to claim 1, wherein at least the upper articulation (8) is a ball joint.

9. The mount according to claim 1, wherein the retaining element (9) or a portion of the retaining element (9) and/or the base (3) is/are detachably fastened.

10. The mount according to claim 1, wherein a power supply having an automatic cable retraction system for a power cable is arranged in the base (3).

11. The mount according to claim 1, wherein a communication unit, a data storage unit and/or a battery charging unit for the tablet PC (2) is/are arranged in the base (3).

12. The mount according to claim 1, wherein at least one line extends from the base (3) through the telescopic arms (5, 7) to the retaining element (9).

13. The mount according to claim 12, wherein the line is connected with a tablet PC contact area which is arranged on the retaining element (9).

14. The mount according to claim 2, wherein at least one of the articulations (4, 6, 8) comprises an actuator.

15. The mount according to claim 14, comprising a preferably mobile control unit for controlling the actuator.

16. The mount according to claim 12, wherein the line is connected with a tablet PC contact area which is arranged on the retaining arm (10).
